(19) United States
(12) Patent Application Publication
(10) Pub. No.: US 2023/0299978 A1
(43) Pub. Date: Sep. 21, 2023

(54) DIGITAL CERTIFICATE REQUEST SYSTEM

(71) Applicant: Target Brands, Inc., Minneapolis, MN (US)

(72) Inventors: Henri J. Gauthier, Maple Grove, MN (US); Jacob W. Gregor, Maple Grove, MN (US); Sartaj S. Sandhu, Minneapolis, MN (US); Timothy J. Sward, Cottage Grove, MN (US); Aaron M. Everett, Minnetonka, MN (US); Shane G. Petrich, Arden Hills, MN (US)

(21) Appl. No.: 17/698,416

(22) Filed: Mar. 18, 2022

(51) Int. Cl. H04L 9/32; H04L 9/30

(52) U.S. Cl. CPC H04L 9/3268; H04L 9/30

(57) ABSTRACT

A computer-implemented method includes receiving a certificate signing request and digital certificate serial number and extracting a public key modulus from the certificate signing request. A stored public key modulus is retrieved for the digital certificate serial number and an error is returned if the public key modulus and the stored public key modulus match so as to improve security of the network server.

### BACKGROUND

Digital Certificates are used by network servers to distribute public keys to clients. Using the public key it receives, the client is able to encrypt messages to and decrypt messages from the network server allowing for secured communication between the server and the client. To prevent fake Digital Certificates, each Digital Certificate is “signed” by a Certificate Authority. This signing involves encrypting a value using a private key known only to the Certificate Authority and placing the encrypted value in the Digital Certificate. Using a public key associated with the Certificate Authority, the client is able to verify the signature by decrypting the encrypted value in the Digital Certificate.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving a certificate signing request and digital certificate serial number and extracting a public key modulus from the certificate signing request. A stored public key modulus is retrieved for the digital certificate serial number and an error is returned if the public key modulus and the stored public key modulus match so as to improve security of the network server.

In accordance with a further embodiment, a method includes receiving a request for a digital certificate and in response, using information provided with the request and a configuration file to select a certificate authority from a plurality of certificate authorities and sending a certificate signing request to the selected certificate authority.

In accordance with a still further embodiment, a system includes a network server submitting a request for a digital certificate and a certificate request server receiving the request for the digital certificate. The certificate request server uses information submitted with the request and a configuration file to identify a certificate authority and submits a request for the digital certificate to the certificate authority.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method of processing requests for Digital Certificates.

FIG. 2 is a block diagram of a system for processing requests for Digital Certificates.

FIG. 3 is an example of an encoded Certificate Signing Request.

FIG. 4 is an example of a decoded Certificate Signing Request.

FIG. 5 is a flow diagram of a method of selecting a certificate authority.

FIG. 6 is a block diagram of an exemplary computing environment on which the various embodiments are practiced.

### DETAILED DESCRIPTION

Digital Certificates are given a limited duration. As such, after a period of time, such as a year, each server must acquire a new Digital Certificate. There are a number of Certificate Authorities that can be used to obtain a new Digital Certificate. In enterprises, the Certificate Authorities that can be used by servers in the enterprise are often limited for security, pricing, or other reasons. As a result, current systems for requesting Digital Certificates require users to interact with a number of user interfaces to determine what Certificate Authorities the network server can use and which of the available Certificate Authorities is best suited for the network server.

In addition, current systems for obtaining Digital Certificates can result in a significant security risk. Specifically, current systems allow the network server to use the same private key/public key pair in the new Digital Certificate. As a result, if the private key has been compromised, anyone who has been using the stolen private key to decrypt communications to the network server will still be able to decrypt communications after the network server begins using the new Digital Certificate.

In the embodiments described below, a Digital Certificate Request tool is provided that simplifies the systems used to select a Certificate Authority and improves the security associated with Digital Certificates. In particular, the embodiments use a configuration file and information provided in a request for a Digital Certificate to select a Certificate Authority and to send a request to the selected Certificate Authority. In some embodiments, the configuration file is used to select the Certificate Authority based on pricing of certificates from different Certificate Authorities, the number of previously-paid-for certificates that have yet to be issued from a Certificate Authority, and the Certificate Authorities currently authorized for network servers in the enterprise. Embodiments also improve the security of Digital Certificates by identifying when a network server has re-used a private key when creating a Certificate Signing Request. When this occurs, the embodiments return an error and prevent a Digital Certificate from being issued based on the re-used private key.

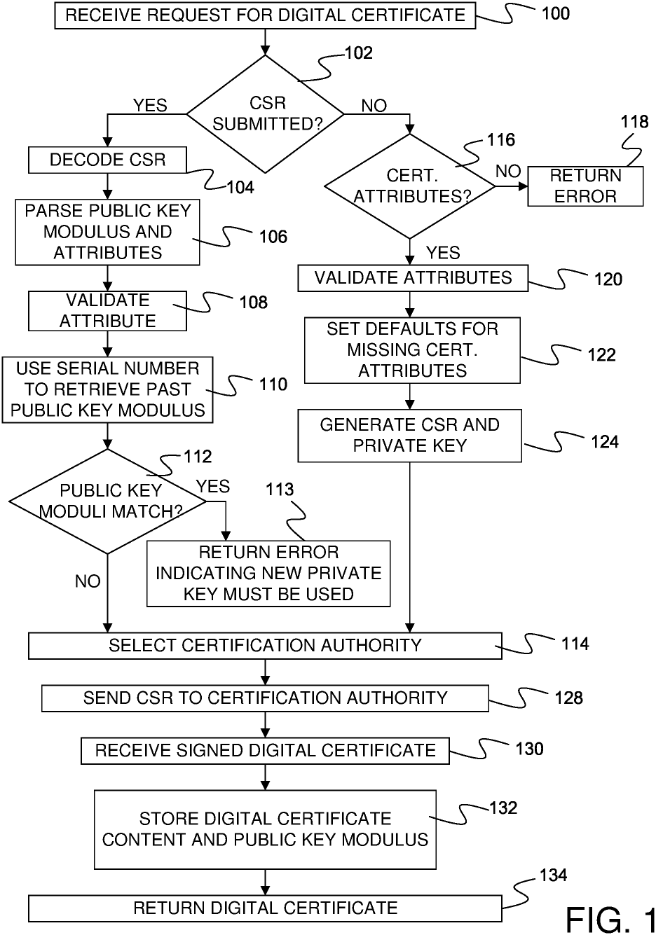

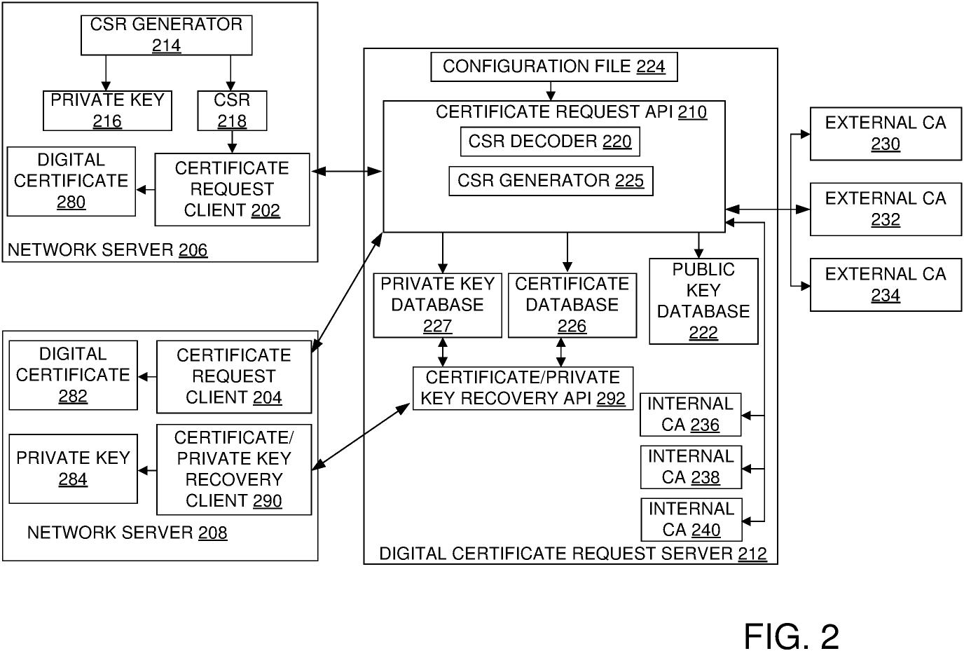

FIG. 1 provides a method of implementing security and selecting certificate authorities in response to Digital Certificate requests. FIG. 2 provides a block diagram of a system 200 used to process Digital Certificate requests.

In FIG. 2, certificate request clients, such as certificate request clients 202 and 204, executing on network servers, such as network servers 206 and 208, make requests for Digital Certificates by calling a certificate request API 210 on a digital certificate request server 212. In accordance with one embodiment, digital certificate clients 202 and 204 are programming modules that are authorized to request digital certificates from certificate request API 210. In accordance with one embodiment, digital certificate clients 202 and 204 are invoked automatically based on an expiration date for a current Digital Certificate such that a new Digital Certificate is automatically requested when the current Digital Certificate is about to expire.

Certificate request API 210 is designed to process requests that include Certificate Signing Requests (CSRs) and to process requests that do not include Certificate Signing Requests (CSRs). For example, in network server 206, a Certificate Signing Request generator 214 generates a private key 216 and a Certificate Signing Request 218. Certificate request client 202 then transmits the Certificate Signing Request to certificate request API 210. Network server 208, on the other hand, does not generate a Certificate Signing Request and as such certificate request client 204 requests a Digital Certificate without providing a Certificate Signing Request.

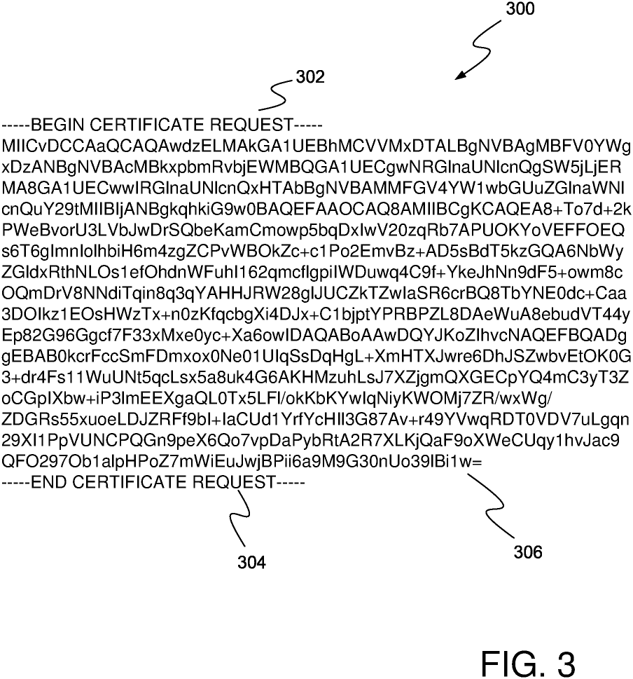

FIG. 3 shows an example of a Certificate Signing Request 300 that includes a BEGIN marker 302, an END marker 304 and an encoded body 306. As described further below, encoded body 306 includes identifying information for the certificate requester, the common name of the network server, and a public key that is the counterpart to private key 216.

In step 100, certificate request API 210 receives the certificate request from a certificate request client such as certificate request client 202 or certificate request client 204. At step 102, certificate request API 210 determines if the request is accompanied by a Certificate Signing Request. If the request is accompanied by a Certificate Signing Request, certificate request API 210 uses a Certificate Signing Request Decoder (CSR Decoder) 220 to decode the Certificate Signing Request at step 104 to provide access to the elements found in the Certificate Signing Request.

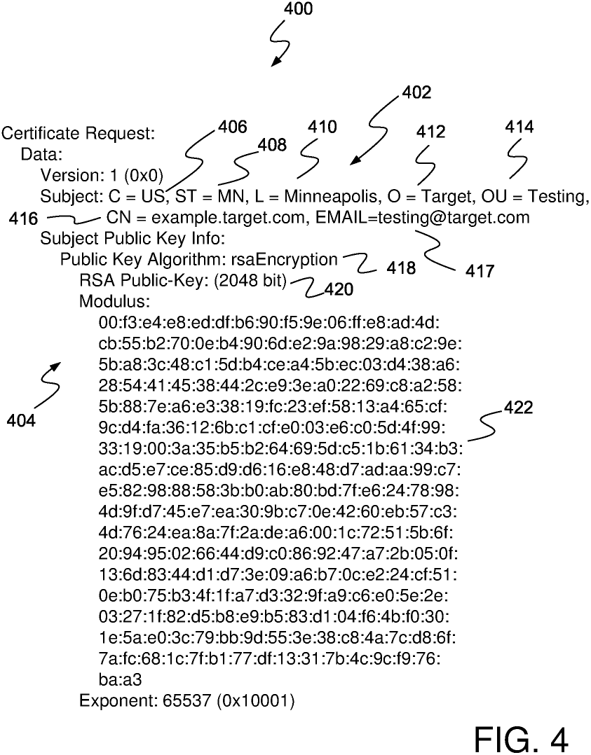

FIG. 4 provides an example of a decoded Certificate Signing Request 400 returned by CSR Decoder 220. Decoded Certificate Signing Request 400 includes requestor attributes 402 and public key information 404. Requestor attributes 402 include a country designation 406, a state designation 408, a locality designation 410, an organization designation 412, an organizational unit designation 414, a common name designation 416 and an email designation 417. Organization designation 412 provides the legal name of the organization requesting the Digital Certificate. Country designation 406, state designation 408, and locality designation 410 provide the country, state and city of the organization. Organizational unit designation 414 provides an internal name of a unit within the organization that is requesting the Digital Certificate. Common name designation 416 provides the address of the network server that the Digital Certificate is being issued for. Email designation 417 provides an email address to contact with questions about issuing the Digital Certificate.

Public key information 404 includes algorithm designation 418, key length designation 420 and public key modulus designation 422 (also referred to as simply the public key designation). Algorithm designation 418 indicates the encryption algorithm that will be used during communications with the network server. Key length designation 420 indicates the length of the keys used in the certificate signing algorithm. Public key designation 422 provides the public key to be used during encrypted communications with the network server.

At step 106, certificate request API 210 parses public key 422 and attributes 402 from the decoded Certificate Signing Request. In particular, each of attributes 402 is parsed.

At step 108, the parsed attributes are validated to ensure that they meet certain requirements. In one embodiment, this validation includes verifying the country, state, and locality are correct for the organization. In addition, the organization name is validated to ensure that it is spelled correctly, including have the correct number of spaces between terms in the name. In addition, the common name is validated to ensure it does not exceed a maximum length and to ensure that it is properly formatted.

When a current Digital Certificate is about to expire and a new Digital Certificate is being requested to replace the current Digital Certificate, a serial number for the current Digital Certificate is sent with the certificate request. At step 110, the serial number, if provided, is used to retrieve the public key modulus associated with the current Digital Certificate from a public key database 222, which holds public key moduli for Digital Certificates previously provided by digital certificate request server 212.

At step 112, certificate request API 210 compares the public key modulus provided in the current Certificate Signing Request to the public key modulus used for the current Digital Certificate. If the public key modulus in the current request matches the public key modulus of the current Digital Certificate, certificate request API 210 returns an error indicating that a new private key must be used in step 113.

By detecting the reuse of a public key, the embodiments are able to determine that a request is attempting to reuse a private key/public key pair. Reuse of a private key/ public key pair represents a security risk because it gives hackers a longer period of time in which to try to determine the private key and if the private key has already been compromised, allows hackers to continue to access encrypted communications to the network server. Since the present embodiments detect reuse of the private key/public key pair and prevent a new digital certificate from being issued for the same private key/public key pair, the embodiments improve computing systems by improving their security. Note that the error is returned in step 113 without receiving the private key.

Certificate request API 210 then uses a configuration file 224 to identify a certificate authority that should issue the digital certificate at step 114 as discussed further below.

When a Certificate Signing Request is not submitted with the request for the Digital Certificate at step 102, certificate request API 210 determines if the request is accompanied by certificate attributes at step 116. In accordance with one embodiment, the certificate attributes that must accompany the request consists of a subset of requestor attributes 402 of Certificate Signing Requests. In particular, the certificate attributes that must be provided are the common name of the network server, an email address to contact with questions regarding the issuance of the Digital Certificate, and the organization unit requesting the Digital Certificate. The remaining attributes-organization, locality, state and country - will be set to default values if not included with the request for the Digital Certificate.

The request can also be accompanied by an identifier of the encryption algorithm and key length that are to be used for encrypted communication with the network server. If the algorithm and/or the key length is not provided, certificate request API 210 will use default values for the algorithm and key length.

If one or more of the required attributes are not provided at step 116, certificate request API 210 returns an error to the certificate request client at step 118.

If all of the required attributes are provided at step 116, the provided attributes a validated at step 120. In accordance with one embodiment, this includes verifying that the country, state, and locality, if provided, are correct for the organization. In addition, the organization name is validated to ensure that it is spelled correctly, including have the correct number of spaces between terms in the name. In addition, the common name is validated to ensure it does not exceed a maximum length and to ensure that it is properly formatted.

At step 122, default values are set for any attributes that are not provided with the request for the Digital Certificate.

Since a Certificate Signing Request was not received with the request for the Digital Certificate at step 102, a Certificate Signing Request and a private key must be generated at step 124. In accordance with one embodiment, certificate request API 210 calls a CSR generator 225 to generate the Certificate Signing Request and the private key. As part of the call to CSR generator 225, certificate request API 210 provides the requestor attributes provided with the request for the Digital Certificate and any default values for requestor attributes that were not provided with the request. In addition, certificate request API 210 provides an identifier for the encryption algorithm to be used during certificate signing and the key length for the public and private keys.

CSR generator 225 first generates a private key/public key pair for the key length set by certificate request API 210. CSR generator 225 then builds the Certificate Signing Request so that it includes the requestor attributes, the signing algorithm identifier, the key length and the public key. CSR generator 225 then encodes the Certificate Signing Request.

Certificate request API 210 then selects a certificate authority at step 114.

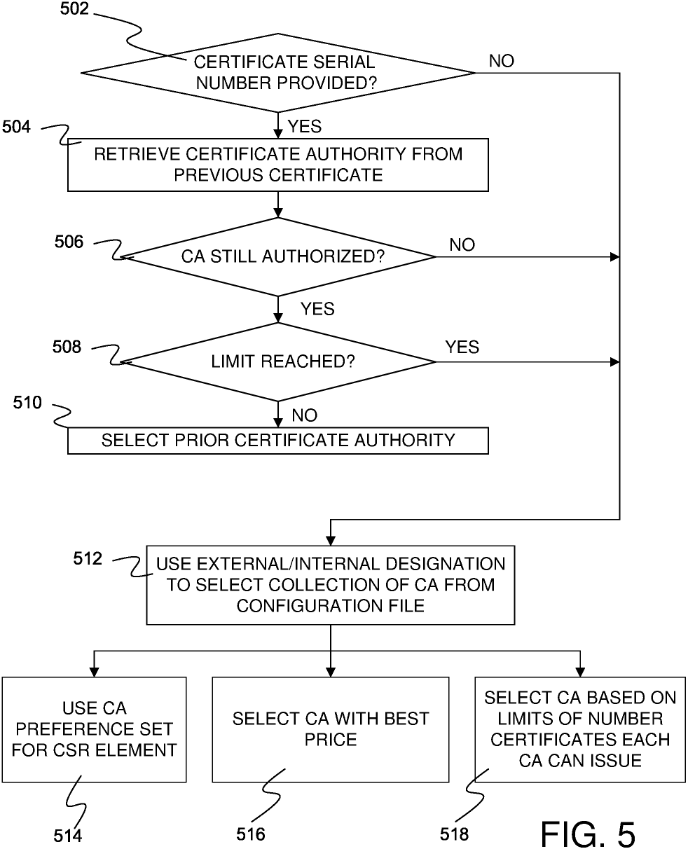

FIG. 5 provides a method of implementing step 114 in accordance with one embodiment. In step 502, certificate request API 210 determines whether a serial number for a current Digital Certificate was provided with the request. If a serial number was provided, the serial number is used to search a certificate database 226 to retrieve the name of the certificate authority that issued the current Digital Certificate.

At step 506, certificate request API 210 uses a configuration file 224 to determine if the certificate authority obtained from certificate database 226 is still authorized to be used to obtain Digital Certificates.

In accordance with one embodiment, configuration file 224 is separate from the executable code in certificate request API 210 so that it can be easily updated without having to redeploy certificate request API 210. In accordance with one embodiment, configuration file 224 includes lists of internal Certificate Authorities and external Certificate Authorities that are currently authorized, pricing per certificate for one or more authorized Certificate Authorities, and limits on the number of Digital Certificates that one or more of the authorized Certificate Authorities can issue. In addition, configuration file 224 includes preferred Certificate Authorities for particular organization units or common names.

When the certificate authority used to issue the current Digital Certificate is still authorized at step 506, certificate request API 210 compares the number of Digital Certificates that have been issued by that certificate authority to any limit set in configuration file 224 for the certificate authority at step 508. If the maximum number of Digital Certificates that can be issued by the certificate authority has not been reached at step 508, certificate request API 210 selects the certificate authority that issued the current Digital Certificate as the certificate authority that should be used to issue the requested Digital Certificate at step 510.

When there is no current Digital Certificate at step 502, or the certificate authority that issued the current Digital Certificate is no longer authorized at step 506, or the maximum number of Digital Certificates have been issued by the certificate authority at step 508, certificate request API examines an external/internal designation at step 512.

In accordance with one embodiment, the external/internal designation is provided with the request for the Digital Certificate and is received with the request at step 100. An external designation indicates that a certificate authority that is trusted outside of the organization is to be selected while an internal designation indicates that a certificate authority that is only trusted within the organization is to be selected.

In step 512, certificate request API 210 uses the external/internal designation to select a collection of certificate authorities designated as either external or internal in configuration file 224. Thus, if the designation indicates that an external certificate authority is to be used, the collection of external certificate authorities that are authorized in configuration file 224 is selected. When the designation indicates that an internal certificate authority is to be used, the collection of internal certificate authorities that are authorized in configuration file 224 is selected.

Certificate request API 210 then uses one or more criteria for selecting a certificate authority from the selected collection. One selection method, shown as step 514, is to select a preferred certificate authority set in configuration file 224 for one of the CSR attributes, such as the organizational unit or the common name, for example. A second selection method, shown as step 516, is to retrieve prices set in configuration file 224 for issuing Digital Certificates from the different certificate authorities in the selected collection of certificate authorities and then selecting the certificate authority with the lowest price. A third selection method, shown as step 518, is to use the limits on the number of Digital Certificates each certificate authority can issue to select the certificate authority. In accordance with one embodiment, the limits are used in conjunction with the number of Digital Certificates previously issued by each certificate authority to determine a number of certificates remaining for each certificate authority. Certificate request API 210 then selects the certificate authority so as to make the number of remaining certificates as close to equal as possible. In other embodiments, certificate request API 210 selects the certificate authority so that the ratio of the remaining certificates for each certificate authority to the limit for each certificate authority are as equal as possible.

After selecting the certification authority at step 114 of FIG. 1, certificate request API 210 sends the Certificate Signing Request to the selected certificate authority at step 128 of FIG. 1. As shown in FIG. 2, the selected certificate authority can be one of a plurality of external certificate authorities, such as external certificate authorities 230, 232 and 234 or one of a plurality of internal certificate authorities, such as internal certificate authorities 236, 238 and 240.

In accordance with one embodiment, a modular design is used in which a separate driver is provided for each certificate authority. Each driver is designed to implement the requirements set by its respective certificate authority for requesting a Digital Certificate. This allows new certificate authorities to be added to the system easily without impacting the remainder of certificate request API 210. It also simplifies modifications that are needed when a certificate authority alters the interface used to request a Digital Certificate.

At step, 130, certificate request API 210 receives the Digital Certificate issued by the selected certificate authority and at step 132 stores the information provided in the Digital Certificate, including the serial number of the Digital Certificate and the certificate authority in certificate database 226.

At step 134, certificate request API 210 returns the Digital Certificate to the certificate request client that requested the Digital Certificate. The certificate request client, such as certificate request client 202 and certificate request client 204, stores the digital certificate on the client’s network server, such as network server 206 and network server 208, respectively, to use during communications with clients.

When the certificate request client, such as certificate request client 204, does not provide the Certificate Signing Request, certificate request API 210 also encrypts and stores the private key generated by CSR generator 225 in a private key database 227. In accordance with one embodiment, the private key is stored with an association to the serial number of the Digital Certificate. In such embodiments, a certificate/private key recovery client 290 is used to obtain the private key stored in private key database 227. To do so, certificate/private key recovery client 290 passes the serial number of the Digital Certificate in a request for the private key made to a certificate/private key recovery API 292. Certificate/private key recovery API 292 uses the Digital Certificate serial number to retrieve the encrypted private key from private key database 227. Certificate/private key recovery API 292 then decrypts the private key and sends the decrypted private key to certificate/private key recovery client 290, which stores the private key as private key 284 on network server 208 so that it can be used during communications with clients.

Certificate/private key recovery client 290 can also be used to recover a digital certificate from digital certificate request server 212. In particular, certificate/private key recovery client 290 sends a request for a digital certificate to certificate/private key recovery API 292 in digital certificate request server 212. In response to the request, certificate/private key recovery API 292 retrieves the attributes of the requested digital certificate from certificate database 226 and returns the retrieved attributes to certificate/private key recovery client 290.

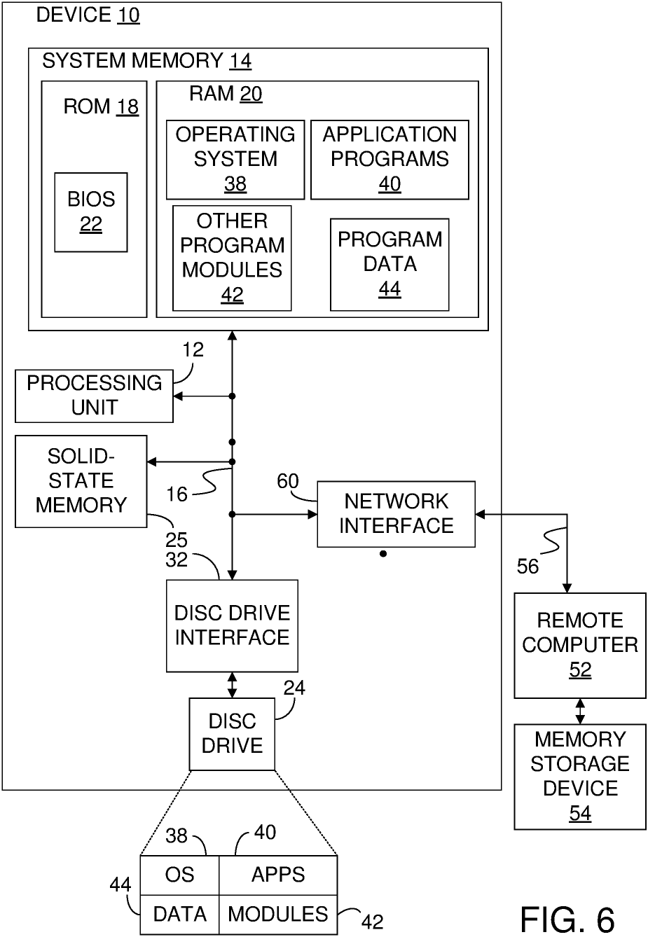

FIG. 6 provides an example of a computing device 10 that network server 206, network server 208 and digital certificate request server 212 can be executed on. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a solid state memory 25 and an optional hard disc drive 24. Hard disc drive 24 is connected to the system bus 16 by a hard disc drive interface 32. The drive and its associated computer-readable media provide nonvolatile storage media for the computing device 10 on which computer-executable instructions and computer-readable data structures may be stored. Other types of media that are readable by a computer may also be used in the exemplary operation environment as non-volatile memory such as solid-state memory.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14, solid state memory 25 and disc drive 24 to perform the methods described above.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 6. The computing device 10 is connected to remote computer 52 through a network interface 60.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 6 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving a certificate signing request and a digital certificate serial number;
extracting a public key modulus from the certificate signing request;
retrieving a stored public key modulus for the digital certificate serial number; and
returning an error if the public key modulus and the stored public key modulus match so as to improve security of the network server.

2. The computer-implemented method of claim 1 wherein extracting the public key modulus comprises decoding the certificate signing request.

3. The computer-implemented method of claim 1 further comprising before retrieving the stored public key modulus, storing the public key modulus for the digital certificate serial number as part of processing a prior request for a digital certificate.

4. The computer-implemented method of claim 3 wherein storing the public key modulus for the digital certificate serial number comprises decoding a prior certificate signing request submitted with the prior request for a digital certificate.

5. The computer-implemented method of claim 1 wherein the error indicates that a new private key must be selected.

6. The computer-implemented method of claim 5 wherein the error is returned without receiving a current private key for the digital certificate serial number.

7. The computer-implemented method of claim 1 wherein the certificate signing request is received as part of a request for a digital certificate.

8. A method comprising:
receiving a request for a digital certificate;
in response to receiving the request, using information provided with the request and a configuration file to select a certificate authority from a plurality of certificate authorities; and
sending a certificate signing request to the selected certificate authority.

9. The method of claim 8 wherein selecting the certificate authority comprises using a common name in the request and an association between the common name and the certificate authority stored in the configuration file.

10. The method of claim 8 wherein selecting the certificate authority comprises determining whether a certificate authority previously used for a digital certificate serial number is still authorized by comparing the previously used certificate authority to authorized certificate authorities found in the configuration file.

11. The method of claim 8 wherein selecting the certificate authority comprises using a designation provided with the request that indicates that an internal certificate authority is to be used and selecting from a collection of internal certificate authorities stored in the configuration file.

12. The method of claim 8 wherein the configuration file indicates a pricing associated with at least one of the certificate authorities.

13. The method of claim 8 wherein the configuration file indicates a number of digital certificates that can be issued at least one certificate authority.

14. The method of claim 8 further comprising, in response to receiving the request, generating the certificate signing request and a private key.

15. A system comprising:
a network server submitting a request for a digital certificate; and
a certificate request server, receiving the request for the digital certificate and using information submitted with the request and a configuration file to identify a certificate authority and submitting a request for the digital certificate to the certificate authority.

16. The system of claim 15 wherein the certificate request server further generates a certificate signing request and a private key in response to receiving the request for the digital certificate.

17. The system of claim 16 wherein the information submitted with the request comprises an organizational unit.

18. The system of claim 15 wherein the information submitted with the request comprises a designation of whether the certificate authority should be internal to an organization or whether the certificate authority should be external to the organization.

19. The system of claim 15 wherein the configuration file comprises pricing for at least one certificate authority.

20. The system of claim 15 wherein the configuration file comprises a maximum number of digital certificates that can be issued by at least one certificate authority.
